(19) United States
(12) Patent Application Publication
(10) Pub. No.: US 2006/0258764 A1
(43) Pub. Date: Nov. 16, 2006

(54) Method of preparing photopolymer with enhanced optical quality using nanoporous membrane and photopolymer prepared by the same

(75) Inventors: Jung Ki Park, Daejeon (KR); Jong Woo Lee, Daejeon (KR); Won Sun Kim, Daejeon (KR)

Correspondence Address: STERNE, KESSLER, GOLDSTEIN & FOX PLLC, 1100 NEW YORK AVENUE, N.W., WASHINGTON, DC, 20005, US

(73) Assignee: Korea Advanced Institute of Science and Technology, Daejeon (KR)

(21) Appl. No.: 11/492,008

(22) Filed: Jul. 25, 2006

Related U.S. Application Data
(63) Continuation of application No. 10/781,946, filed on Feb. 20, 2004.

(51) Int. Cl. C08F 2/50

(52) U.S. Cl. 522/6

(57) ABSTRACT

The present invention relates to a method of preparing photopolymers using nanoporous membranes. More specifically, the present invention relates to a method of preparing a photopolymer with enhanced optical quality by performing photopolymerization in a polymer having nano-sized pores. The invention also relates to a photopolymer prepared by the method.

### BACKGROUND OF THE INVENTION

1. Field of the Invention

The present invention relates to a method of preparing photopolymers using nanoporous membranes. More specifically, the present invention relates to a method of preparing photopolymers with enhanced optical quality by performing photopolymerization in a polymer having nano-sized pores. The invention also relates to photopolymers prepared by the method.

2. Related Art

With great advances in information technology over the last 20 years, there has been an urgent need to develop a device material capable of quickly displaying, transferring and storing large quantities of information. Intense and thorough research has been focused on the development of a material for information display, transfer and storage-using light.

Research into optical communication fields transferring large quantities of information at a fast rate has been actively conducted, and optical communication devices have reached the commercial state. However, a three-dimensional information storage device is not yet commercially available due to a lack of progress in the development of a suitable device material.

Photoisomerization materials, refractile materials, and photopolymers have been studied as three-dimensional optical information storage materials. A photopolymer is obtained by photopolymerizing a photopolymerizable monomer and a photoinitiator in a matrix polymer. Using an interference pattern of two lights for photopolymerization, the monomer present in a first region exposed to light is photopolymerized by the photoinitiator, while the monomer in a second region that is not exposed to light is diffused into the first region exposed to light, due to a concentration gradient, so that the monomer is photopolymerized. Therefore, the portion having a high concentration of a photopolymerized polymer is formed in the first region, whereas the matrix polymer mainly exists in the second region. Thus, a diffraction grating is formed, attributable to the refractive index difference between the two regions.

Since the photopolymer forms the grating by photopolymerization, it can be applied for ROM (Read Only Memory) type three-dimensional information storage materials. Further, the photopolymer can produce in-situ diffraction grating, based on the interference of two lights. However, such a photopolymer is disadvantageous due to a 10% volume contraction upon photopolymerization, which causes deterioration of the diffraction grating formed by photopolymerization. In addition, the polymer, resulting from diffusion of the monomer upon photopolymerization, is phase-separated from the matrix polymer, thereby producing light scattering. As a result, limitations are imposed on the thickness of the prepared film. To prevent the volume contraction caused by the photopolymerization, a photopolymerizable component is filled into a rigid nanoporous glass to prepare a desired photopolymer (Schnoes, M. G. et al., Optics Letters 24:658 (1999)). By determining diffraction efficiency and deterioration of the grating by volume contraction, it can be found that as the amount of the monomer in pores of the nanoporous glass increases, the likelihood of the glass matrix cracking increases, and thus the diffraction efficiency of the photopolymer is not expected to increase.

### SUMMARY OF THE INVENTION

It is an aspect of the present invention to provide a method of preparing a photopolymer with enhanced optical quality, characterized in that a monomer is photopolymerized and is incorporated into nanopores of a polymer having a nanoporous structure. In the present invention, the photopolymerized polymer phase can be nano-sized, thus preventing reduction of transmittance due to phase separation and inhibiting volume contraction.

The present invention also provides a photopolymer prepared by the method described herein.

### BRIEF DESCRIPTION OF THE DRAWINGS

FIG. 1A is a graph showing transmittance of a photopolymer prepared in Example 1 of the present invention.

FIG. 1B is a graph showing transmittance of a photopolymer prepared in Example 2 of the present invention.

FIG. 2A is a graph showing diffraction efficiency of the photopolymer prepared in Example 1 of the present invention.

FIG. 2B is a graph showing diffraction efficiency of the photopolymer prepared in Example 2 of the present invention.

### DETAILED DESCRIPTION OF THE INVENTION

The present invention is directed to a method of preparing a photopolymer, comprising photopolymerizing a monomer, wherein the monomer is photopolymerized in a polymer having a nanoporous structure.

The present invention is directed to a method of preparing a photopolymer, capable of inhibiting light loss by light scattering, in which a monomer is photopolymerized in a polymer having a nanoporous structure. The photopolymer is prepared in the polymer having the nanoporous structure to also inhibit light scattering loss due to phase separation caused by the photopolymerization of the monomer upon the preparation of the photopolymer. Thus, the region where the phase separation occurs can be nano-sized, resulting in drastically reduced light scattering loss and improved diffraction efficiency for material recording properties.

In the present invention, any polymer having a nano-sized porous structure can be used. In some embodiments, the polymer is synthesized from an ionomer which forms a nanoporous structure. In some embodiments, the polymer is synthesized from a block copolymer comprising a hydrophilic group and a hydrophobic group in turns. In some embodiments, a polymer having an about 5 nm to about 100 nm sized porous structure can be used. Polymers can be, but are not limited to, cellulose acetate, polymethylmethacrylate, polyvinylalcohol, polyvinylacetate, polystyrene, polyurethane, copolymers thereof, ionomers thereof, or mixtures thereof.

In the present invention, the polymer can have an average porous structure size of about 5 nm to about 100 nm in diameter. The shape of the pores can vary, and thus the diameter refers to an average diameter of the pore. The diameter of a pore is the maximum distance between two points on the pore. If the porous membrane is less than about 5 nm in diameter, the amount of the monomer used is limited upon preparation of the photopolymer. If the pore size exceeds about 100 nm in diameter, scattering loss of the photopolymer by phase separation increases. In some embodiments, the pore size is between about 5 nm and about 100 nm.

In the present invention, a monomer, a photoinitiator, a photosensitizer and a solvent known for the preparation of the photopolymer can be used. Various monomers can be used. A monomer is any organic compound having a reacting group capable of polymerization by light. In some embodiments, the monomer can be, but is not limited to, acrylamide, methyl methacrylate, ethyl methacrylate, N,N-isopropyl acrylamide, N-vinylcarbazole, N-vinyl-2-pyrrolidone, or mixtures thereof. In some embodiments, the amount of monomer is about 30% to about 55% by weight of the total composition. In some embodiments, a mixture of two monomers has a mixing ratio (by weight) of about 50:50 to about 20:80.

Various photoinitiators can be used. A photoinitiator is any material that forms a radical that initiates polymerization by light. In some embodiments, the photoinitiator can be, but is not limited to, triethanolamine, butyl hydroperoxide, fluorene, pyrene-triethylamine, acyphosphine oxide, or mixtures thereof. In some embodiments, the amount of photoinitiator is about 44.9% to about 59.5% by weight. In some embodiments, a mixture of two photoinitiators has a mixing ratio (by weight) of about 10:90 to about 50:50. In some embodiments, the two photoinitiators are triethanolamine and fluorene.

Various photosensitizers can be used. A photosensitizer is any material that increases the sensitivity of the monomer to light. In some embodiments, the photosensitizer can be, but is not limited to, methylene blue, 2,4,5,7-tetrabromofluorescein disodium salt, 3,3-carbonylbis diethylaminobenzopyrane, phloxine B (Sigma Aldrich. Co., St. Louis, Mo.), thionine, and mixtures thereof. In some embodiments, the amount of photosensitizer is about 0.1% to about 0.5% by weight. In some embodiments, a mixture of two photosensitizers has a mixing ratio (by weight) of about 10:90 to about 50:50. In some embodiments, the two photosensitizers are methylene blue and thionine.

Various solvent can be used. A solvent is any material capable of dissolving a photopolymer, i.e., a monomer, a photoinitiator and a photosensitizer. In some embodiments, the solvents are selected from the group consisting of, but not limited to, methanol, tetrahydrofuran and water.

In the present invention, the monomer, photoinitiator and photosensitizer can be used in various amounts. In some embodiments, about 30% to about 55% by weight of the monomer, about 44.9% to about 59.5% by weight of the photoinitiator, and about 0.1% to about 0.5% by weight of the photosensitizer are used. In some embodiments, 30-55% by weight of the monomer, 44.9-59.5% by weight of the photoinitiator and 0.1-0.5% by weight of the photosensitizer are used to prepare the photopolymer.

The photopolymerization of the present invention can occur under known photopolymerization conditions (Waldman, D. A. et al., J. Imaging Sci. Tech. 41:497 (1997)). For example, photopolymerization can occur upon exposure to two recording beams (633 nm laser) having identical light intensities in a range of about 2 mW/cm² to about 100 mW/cm² for about 1 second to about 500 seconds. In some embodiments, photopolymerization can occur upon exposure to two recording beams (633 nm laser) having identical light intensities in a range of about 2 mW/cm to about 10 mW/cm² for about 30 seconds to about 200 seconds.

The present invention is also directed to a photopolymer prepared by the method described herein.

Having generally described this invention, a further understanding can be obtained by reference to the examples provided herein. These examples are for purposes of illustration only and are not intended to be limiting unless otherwise specified.

### EXAMPLE 1

To prepare a photopolymer solution, 0.32 g (46.95 wt %) of acrylamide as a photopolymerizable monomer, 0.36 g (52.82 wt %) of triethanolamine as a photoinitiator, and 0.0016 g (0.23 wt %) of methylene blue as a photosensitizer were introduced to 0.05 L of a tetrahydrofuran solvent.

A polymer having a nanoporous structure (cellulose acetate membrane having 10 nm sized pores) was immersed into the photopolymer solution for 24 hours, followed by volatilizing the solvent to create a polymer film. Thereafter, the polymer film was exposed to two recording beams (633 nm laser) having identical light intensities in a range of 2-10 mW/cm² for about 30-200 seconds, thus preparing a desired photopolymer.

### EXAMPLE 2

To prepare a photopolymer solution, 0.32 g (19.03 wt %) of acrylamide as a photopolymerizable monomer, 0.36 g (21.41 wt %) of triethanolamine as a photoinitiator, 0.0016 g (0.09 wt %) of methylene blue as a photosensitizer, and 1 g (59.47 wt %) of polyvinylalcohol as a binder were added to 0.1 L of a tetrahydrofuran solvent. The photopolymer solution was then cast on a glass substrate, and the solvent was volatilized to create a polymer film. Thereafter, the polymer film was exposed to two recording beams (633 nm laser) having identical light intensities in the range of 2-10 mW/cm² for about 30-200 seconds, thus preparing a desired photopolymer.

### EXAMPLE 3

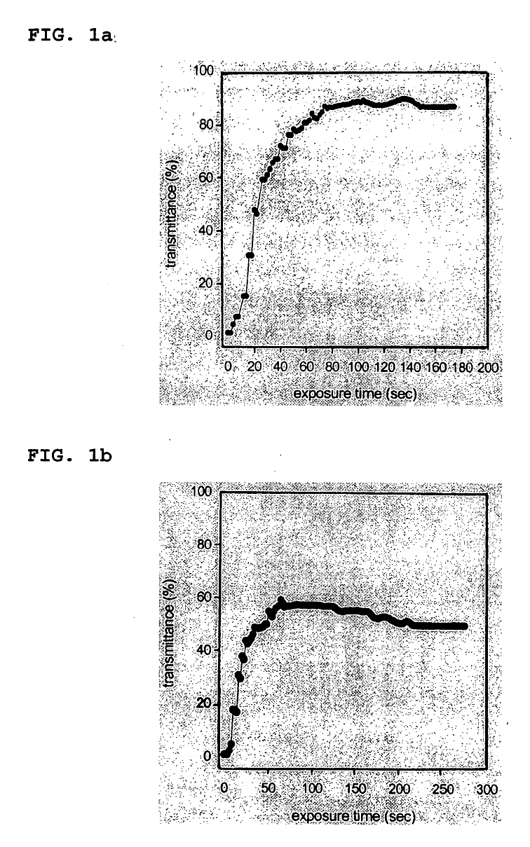

To confirm the effects of a nanoporous structure on preventing light scattering upon preparation of a photopolymer, the photopolymers prepared in Example 1 and Example 2 were measured for transmittance according to an exposure time upon exposure to two recording beams (633 nm laser) having identical light intensities in the range of 2-10 mW/cm² for about 30-200 seconds. The results are shown in FIGS. 1A and 1B.

As seen in FIGS. 1A and 1B, the photopolymer prepared in Example 1 is higher in light transmittance than that of the photopolymer prepared in Example 2, thus exhibiting low light scattering loss.

### EXAMPLE 4

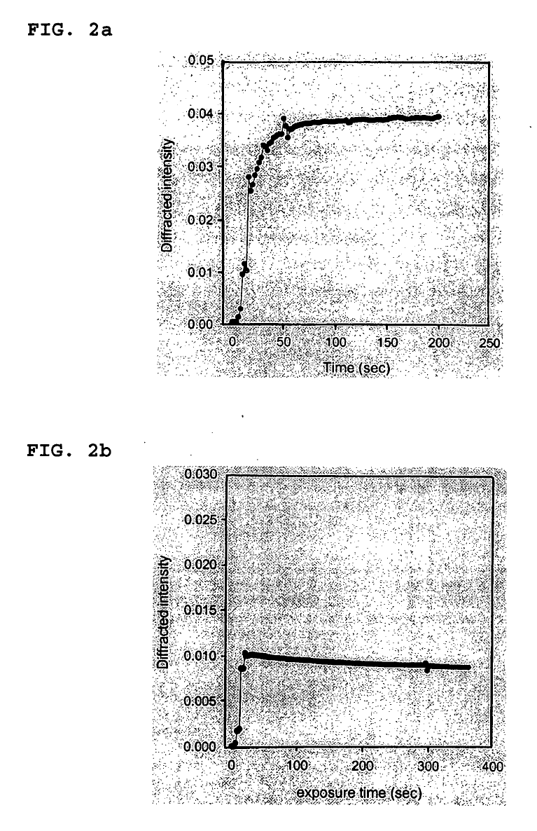

To confirm the effects of a nanoporous structure on recording properties of a photopolymer, the photopolymers prepared in Example 1 and Example 2 were measured for diffraction efficiency according to an exposure time upon exposure to two recording beams (633 nm laser) having identical light intensities in the range of 2-10 mW/cm² for about 30-200 seconds. The results are shown in FIGS. 2A and 2B.

As shown in FIGS. 2A and 2B, the photopolymer prepared in Example 1 has superior diffraction efficiency to that of the photopolymer of Example 2.

As described herein, the present invention provides a method of preparing a photopolymer by use of a polymer having a nanoporous structure, and a photopolymer prepared by the same. The photopolymer of the present invention is advantageous in terms of drastically reduced light scattering loss, thus enhancing optical quality and diffraction efficiency. Therefore, the photopolymer of the present invention is suitable for application in information storage device materials.

These examples illustrate one possible method of the present invention. While the invention has been particularly shown and described with reference to some embodiments thereof, it will be understood by those skilled in the art that they have been presented by way of example only, and not limitation, and various changes in form and details can be made therein without departing from the spirit and scope of the invention. Thus, the breadth and scope of the present invention should not be limited by any of the above-described exemplary embodiments, but should be defined only in accordance with the following claims and their equivalents.

All documents cited herein, including journal articles or abstracts, published or corresponding U.S. or foreign patent applications, issued or foreign patents, or any other documents, are each entirely incorporated by reference herein, including all data, tables, figures, and text presented in the cited documents.

What is claimed is:

1. A method of preparing a photopolymer, the method comprising photopolymerizing a monomer, wherein the monomer is photopolymerized in a polymer having a nanoporous structure.

2. The method of claim 1, wherein the polymer having a nanoporous structure comprises pores of about 5 nm to about 100 nm in diameter.

3. The method of claim 1, wherein the polymer having a nanoporous structure is any one of cellulose acetate, polymethylmethacrylate, polyvinylalcohol, polyvinylacetate, polystyrene, polyurethane, copolymers thereof, ionomers thereof, and mixtures thereof.

4. The method of claim 1, wherein the monomer is any one of acrylamide, methyl methacrylate, ethyl methacrylate, N,N-isopropyl acrylamide, N-vinylcarbazole, N-vinyl-2-pyrrolidone, and mixtures thereof.

5. The method of claim 1, wherein the photopolymerizing is performed in the presence of a photoinitiator, which is any one of triethanolamine, butyl hydroperoxide, fluorene, pyrene-triethylamine, acyphosphine oxide, and mixtures thereof.

6. The method of claim 1, wherein the photopolymerizing is performed in the presence of a photosensitizer, which is any one of methylene blue, 2,4,5,7-tetrabromofluorescein disodium salt, 3,3-carbonylbis diethylaminobenzopyrane, thionine, and mixtures thereof.

7. The method of claim 1, wherein the photopolymerizing is performed upon exposure to two recording beams having identical light intensities in a range of about 2 mW/cm² to about 10 mW/cm² for about 30 seconds to about 200 seconds.

8. The method of claim 1, wherein the monomer is about 40% to about 55% by weight, said photoinitiator is about 44.9% to about 59.5% by weight, and said photosensitizer is about 0.1% to about 0.5% by weight.

9. A photopolymer prepared by the method of claim 1.
